(19) United States
(12) Patent Application Publication
(10) Pub. No.: US 2007/0139174 A1
(43) Pub. Date: Jun. 21, 2007

(54) Proximity sensing system

(76) Inventor: Jason Stephen Perkes, London (GB)

Correspondence Address: Anthony R Barkume, 20 Gateway Lane, Manorville, NY, 11949, US

(21) Appl. No.: 10/561,277

(22) PCT Filed: Jun. 18, 2004
(86) PCT No.: PCT/GB04/02615

§ 371 Date: Dec. 14, 2005

(30) Foreign Application Priority Data
Jun. 18, 2003 (GB) 0314156.1

(51) Int. Cl. B60Q 1/00

(52) U.S. Cl. 340/435

(57) ABSTRACT

A vehicle proximity sensing system which can be mounted into or near the mirror housing assembly of a vehicle such as a large public or commercial vehicle which detects obstacles near the front of the vehicle e.g. under the exterior rear mirror or otherwise not visible to the driver and sends a control signal into, the cab of the same vehicle to alert the driver by way of a warning device.

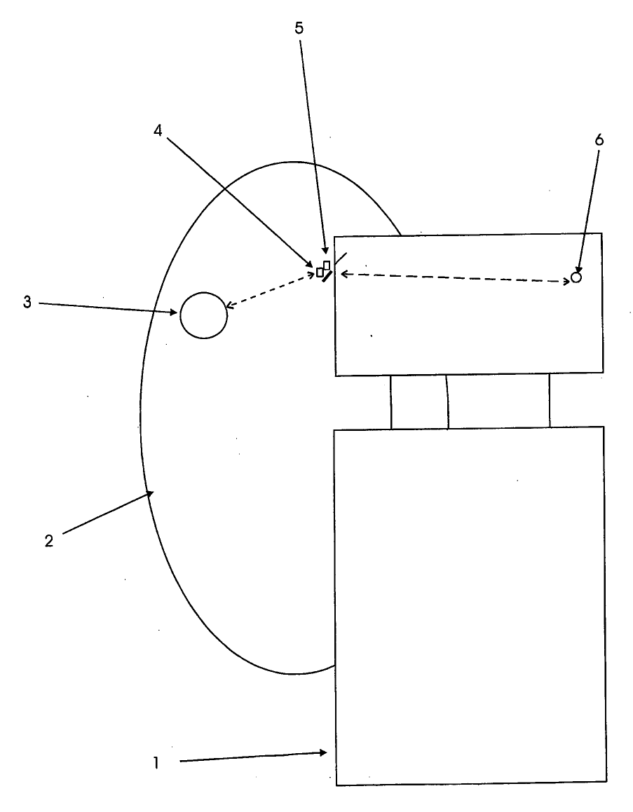

The present invention relates to a vehicle area sensing system whereby the area sensing means forms part of and is contained in the mirror housing assembly of a vehicle such as a large public or commercial vehicle and/or into the cab of the same vehicle.

These vehicles, due to their size and construction, have a number of areas around the vehicle where the driver cannot directly see.

In particular it is well known that exterior or wing mirrors on vehicles do not rectify all blind spots where the field of view of the driver is limited by the configuration and set up of the mirror, size of vehicle, position of the driver etc. and there have been many arrangements of fixed and adjustable mirrors which enable these blind spots to be overcome.

There have also been many arrangements using camera monitor systems to reduce the reduction in view. There have also been many arrangements using other forms of non contact sensing to reduce the reduction in view.

Attempts have been made to have mirrors which change their angle when the steering wheels of the vehicle are turned and U.S. Pat. No. 6,151,175, EP 1026035, U.S. Pat. No. 4,229,992, CA 1148395, CA 2203023, AU 3492695, U.S. Pat. No. 6,315,419 and U.S. Pat. No. 3,640,609 and Patent Applications PCT/GB02/02717, US20020005778A1, WO0185491 and WO9701246 describe systems and devices which automatically adjust mirrors in an articulated lorry. Even with this type of adjustable system there can be a problem with visibility under or around the driver's door and under any wing mirror.

We have now devised a system whereby the reduction in field of view is eliminated or reduced by delivering an interpreted signal to the driver.

According to the invention there is provided an area sensing system for detecting obstacles proximate to a large public or commercial vehicle with an exterior mirror in a mirror housing which system comprises (i) an area sensing means mounted in the mirror housing of an exterior mirror of the vehicle which sensing means is capable of detecting obstacles (ii) a control signal transmission means mounted inside or adjacent to the mirror housing and connected to the area sensing means in which, when the area sensing means detects an obstacle a control signal is sent by the control signal transmission means to a control signal receiving means inside the cab of the vehicle.

This control signal transmission means may be mounted directly inside the mirror housing or mounted outside of the housing which is fitted to the outside of the vehicle; for example the control signal transmission means may be mounted onto a fixed window next to the mirror housing.

The area sensing means preferably produces a digital area signal based on the spatial range of detection and preferably the digital area signal is processed and analysed by a digital signal processing means. The combination of area sensing means and digital signal processing means can enable the system to be capable of distinguishing between different types of object. The system is preferably also able to determine the speed and direction of the vehicle from the sensing means without the use of signals from the vehicle's electrical or electronic system.

The area sensing means is preferably a non-contact means which can sense obstacles and objects in its area of coverage, and can e.g. be based on a radar technology or electromagnetic sensing or magnetic sensing using a magnetometer or combination of radar and magnetometer and magnetic field sensing. Ultra-sound or infra red or other remote non-contact distance sensing means may also be used with the radar or magnetometer or magnetic field sensing. A magnetometer is particularly useful in detecting ferromagnetic obstructions such as vehicles, motor cycles, bicycles etc. More than one type of area sensing means can be used.

The area sensing means is preferably located in the mirror housing and is positioned to point substantially in a rearward and downward orientation and the sensing means is herein described as rearward facing. However there could still be some coverage forward of the mirror housing when looking at the plan view but the major part of the area of coverage provided by the device is rearward of the mirror assembly.

The area sensing means is not of the type intended to relay a live video type image onto a monitor type screen although the system could use data from an image sensing means if available.

Preferably there is a control signal receiving means inside the driver's cab of the vehicle which can interpret received control signals to deliver a controlled warning signal to the driver. This warning signal means may be in the form of either or both of a visual or audible means. When the signal is received a driver warning is actuated to alert the driver of the danger. In one embodiment of the invention the signal changes as the vehicle approaches the obstacle e.g. the signal is distance specific. For example when there is an audio signal the pitch and/or volume of the signal can increase and when the signal is visual the colour or intensity of the signal can change e.g. there could be a series of lights such as LEDs, more of which are turned on as the obstacle is approached.

The control signal transmitting and receiving means is preferably wireless e.g. in the form of either a radio based means or infra red means etc.

In use, when an obstacle or hazard is detected by the area sensing means, a control signal is transmitted through the control signal transmission means and received by the control signal receiving means mounted inside the cab of the vehicle, the signal is processed and the appropriate warning delivered to the driver.

The control signal receiving means and driver warning means may be mounted together in the same unit and this would require a single power connection from within the vehicle.

Preferably the area sensing means and control signal transmitting means would require only one power connection.

The device of the present invention can be used with a vision based self adjusting mirror. Such a mirror is described in Patent Application WO 02/102621 the contents of which are included by reference.

In this self adjusting mirror system there is a mirror assembly for a vehicle, which incorporates a mirror having a reflective surface, a mirror adjusting means and an image sensing means whereby the mirror adjusting means is able to adjust the orientation of the reflective surface of the mirror in response to images perceived by the image sensing means.

In use, the mirror is adjusted automatically in the normal way to give the driver the appropriate view in the reflective surface of his mirror and the image sensing means is set up to detect a specific image. When the vehicle turns, the specific image will start to move out of the field of view of the image sensing means; the image sensing means then adjusts itself so that the specific image stays in its field of view and this causes the mirror adjusting means to adjust the reflective surface of the mirror so as to maintain the appropriate field of view for the driver.

The mirror adjusting means can be any of the conventionally used means which are widely used on vehicles to operate electrically mirrors from inside the vehicle. In the present invention the orientation of the reflective surface of the mirror is controlled by the orientation of the image sensing means instead of the driver of the vehicle.

There can be an indicator light which will be automatically activated when the mirror adjusting means and image sensing means are operating, this indicator light can be located at a convenient location e.g. in the mirror housing etc. The indicator light can be a steady light or it can flash in a manner similar to indicator lights.

Preferably the mirror assembly incorporates a means to transmit additional data to modules that are integrated to the vehicle's electrical system e.g. by direct cable connection or by infrared or wireless remote link. This would enable there to be, for example, supplementary control of the whole vehicle turn indicator circuit. This could come into effect when articulation is sensed and can activate the suitable turn signals on the vehicle. The turn signals on the vehicle can be activated independently of hazard warning or reversing light circuits or in addition to these lighting circuits. If a combination of these lights are activated together and an input from the mirror system indicator is sensed then these lights may be flashed together or in a preprogrammed sequence.

Preferably there is a remote control switch fitted within the cab that allows the driver to override the mirror system at will. The signal transmitted from this module to the mirror can be by a wireless link or can be wired into the vehicle's power supply or powered by suitable battery device. The manual override control for the driver may also allow for a driver controlled up-down adjustment of the reflective mirror to accommodate different size drivers of the vehicle.

The image sensing means can be rigidly mounted to the mirror housing so that adjustment of the mirror surface by the adjusting means will not alter the position of the image sensing means. Alternatively the image sensing means can be mounted behind the mirror and connected to the mirror surface so that, as the mirror surface is adjusted, the visual field of view afforded by the image sensing means changes sufficiently to allow this. The image sensing means behind the mirror glass may be positioned such that it looks through the glass, or is positioned behind the plane of the mirror but beyond the perimeter edge of the mirror. If the image sensing means looks through the glass the glass may be coated with a one way mirror material such that the imaging sensor looks through the glass but from the reflective side there is no interruption of the reflective surface.

Using this system in conjunction with the present invention enables an obstacle to be detected and then the mirror automatically adjusting to bring the obstacle in the field of view of the driver or the driver adjusting the mirror so that the image is in the field of view of the driver and then as the vehicle turns mirror is automatically adjusted to maintain the image in the field of view of the driver, this provides an improved safety feature.

The invention is illustrated in the accompanying drawing in which an articulated vehicle (1) has a remote area sensing means (4) which can detect obstacles in its field of view (2) and which is mounted within or adjacent to the housing of an exterior wing mirror (7) and monitors an area shown as (2). There is a wireless control signal transmitter means (5) which is connected to the sensing means (4). There is a control signal wireless receiver in the driver's cab shown at (6) which includes an alarm system and the receiver can receive a control signal from the wireless control signal transmitter (5).

In use, where there is an obstacle (3) which can be in the blind spot of the driver; the area sensing means (4) will detect this obstacle. The sensing means sends a signal to wireless control signal transmitting means (5) and a wireless signal is then sent to receiver (6) which activates an alarm which can be an audio and/or visual signal and so alerts the driver to the obstacle.

The signal received by (6) can be processed so that information is available or a warning can be provided to indicate to the driver the distance away from the obstacle, the location of the obstacle and the rate of approach to the obstacle, which can be available in a suitable form e.g. on a screen, indicated by the colour or intensity of a light signal or the pitch and/or sound of an audio signal which relates to a degree of proximity to the detected object or obstacle.

1-15. (canceled)

16. A sensing system for detecting obstacles by a vehicle with an exterior mirror inside a mirror housing which system comprises (i) an area sensing means mounted in the mirror housing of an exterior mirror of the vehicle which area sensing means is capable of detecting obstacles (ii) a control signal transmission means mounted inside or adjacent to the mirror housing and (iii) a control signal receiving means in which the control signal transmission means is connected to the area sensing means and in which, when the area sensing means detects an obstacle, a control signal is sent by the control signal transmission means to the control signal receiving means inside the cab of the vehicle.

17. A system according to claim 16 in which the control signal transmission means is mounted in a mounting position selected from directly inside the mirror housing and outside of the mirror housing.

18. A system according to claim 16 in which the area sensing means produces a digital signal based on the area of detection and the digital signal is processed and analyzed by a digital signal processing means which then interprets and outputs the control signal.

19. A system according to claim 16 in which the area sensing means is a means which can sense obstacles and objects in its field of view and is a means selected from radar technology, electromagnetic radiation, magnetic effects using a magnetometer, ultra-sound and infra-red.

20. A system according to claim 18 in which the area sensing means is a means which can sense obstacles and objects in its field of view, and is a means selected from radar technology, electromagnetic radiation, magnetic effects using a magnetometer, ultra-sound and infra-red.

21. A system according to claim 16 in which the vehicle has a driver's cab and there is a control signal receiving means inside the driver's cab of the vehicle connected to a driver's warning means which can deliver a warning to the driver.

22. A system according to claim 16 in which the vehicle has a driver's cab and there is a control signal receiving means inside the driver's cab of the vehicle connected to a driver's warning means which can deliver a warning to the driver.

23. A system according to claim 22 in which the said warning is in the form of at least one of a visual and audible warning.

24. A system according to claim 22 in which the warning changes as the distance from the obstacle changes.

25. A system according to claim 23 in which the warning is an audible warning and a response selected from at least one of the pitch and the volume of the audible warning which increase as the distance from the obstacle decreases.

26. A system according to claim 23 in which the warning is a visual warning and a response selected from at least one the brightness and colour of the visual warning increases as the distance from the obstacle decreases.

27. A system according to claim 16 in which the control signal transmission and receiving means are wireless.

28. A system according to claim 18 in which the control signal transmission and receiving means are wireless.

29. A system according to claim 22 in which the control signal receiving means and driver warning means are mounted within the same unit and together require only a single power connection from inside the vehicle.

30. A system according claim 16 in which the control signal transmission means is wireless and the area sensing means and the wireless control signal transmission means together require only one power connection.

31. A system according to claim 16 in which the mirror is a self adjusting mirror.

32. A system according to claim 18 in which the mirror is a self adjusting mirror.

33. A system according to claim 31 in which the self adjusting mirror comprises a mirror assembly which incorporates (i) a mirror having a reflective surface; (ii) a mirror adjusting means and (iii) an image sensing means whereby the mirror adjusting means is able to adjust the orientation of the reflective surface of the mirror in response to images perceived by the image sensing means.
